(19) United States
(12) Patent Application Publication
(10) Pub. No.: US 2026/0329382 A1
(43) Pub. Date: Oct. 22, 2026

(54) IMAGE PROCESSING APPARATUS CAPABLE OF INDICATING OBJECT BY HAPTIC SENSATION, METHOD OF CONTROLLING IMAGE PROCESSING APPARATUS, METHOD OF REPRODUCING IMAGE, AND STORAGE MEDIUM

(71) Applicant: CANON KABUSHIKI KAISHA, Tokyo (JP)

(72) Inventor: SHOTA YAMAGUCHI, Tokyo (JP)

(21) Appl. No.: 19/575,252

(22) Filed: Mar. 23, 2026

(30) Foreign Application Priority Data
Apr. 17, 2025 (JP) 2025-068003

(51) Int. Cl. G06F 3/01; G06T 15/20; G06T 15/40

(52) U.S. Cl. CPC G06F 3/016; G06F 3/011; G06T 15/205; G06T 15/40

(57) ABSTRACT

An image processing apparatus that is capable of indicating an object by haptic sensation existing in an occlusion area without hindering viewing of an image. Haptic information used when indicating an object included in an image by haptic sensation is generated. A result of determination on whether or not an object for which the haptic information has been generated exists in an occlusion area in the image is acquired as shielding information. Metadata having the haptic information and the shielding information is added to the image.

### BACKGROUND

### Field of the Technology

The present disclosure relates to an image processing apparatus that is capable of indicating an object by haptic sensation, a method of controlling the image processing apparatus, a storage medium, and a method of reproducing an image.

### Description of the Related Art

Conventionally, there has been known a technique for recording and outputting haptic information in association with an object and a background. For example, Japanese Laid-Open Patent Publication (Kokai) No. 2011-146821 describes a technique for outputting, in a case where a user touches a boundary area between an object and a background on a display screen, haptic information on the touched boundary area.

Incidentally, a viewer of video content (such as a movie) sometimes desires to confirm an object existing in an area hidden by an object on the near side (hereinafter referred to as the “occlusion area”) to enhance realism of the video content. However, there is a problem that it is difficult to remove the object on the near side while the viewer is viewing the video content.

### SUMMARY

The present disclosure is directed to providing a mechanism that makes it possible to indicate an object existing in an occlusion area by haptic sensation without hindering viewing of an image.

In a first aspect of the present disclosure, there is provided an image processing apparatus including at least one processor, and a memory storing instructions that, when executed by the at least one processor, causes the at least one processor to function as: a generation unit configured to generate haptic information used when indicating an object included in an image by haptic sensation, a determination unit configured to acquire a result of determination on whether or not an object for which the haptic information has been generated exists in an occlusion area in the image, as shielding information, and an addition unit configured to add metadata having the haptic information and the shielding information to the image.

In a second aspect of the present disclosure, there is provided an image processing apparatus including at least one processor, and a memory storing instructions that, when executed by the at least one processor, causes the at least one processor to function as: a generation unit configured to generate haptic information used when indicating an object included in an image by haptic sensation, a first acquisition unit configured to acquire three-dimensional object information of an object included in the image, an addition unit configured to add metadata having the haptic information and the three-dimensional object information to the image, a second acquisition unit configured to acquire a viewpoint position and a sight direction of a viewer of the image, and a determination unit configured to determine whether or not an object exists in an occlusion area in the image, by using the three-dimensional object information, the viewpoint position, and the sight direction.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a configuration of an image processing apparatus and the like in a first embodiment.

FIG. 2 is a flowchart showing the operation of the image processing apparatus.

FIG. 3 is a flowchart of a video content generation process in the first embodiment.

FIGS. 4A and 4B are diagrams showing an unshielded state and a shielded state of an object, respectively.

FIG. 5 is a diagram showing a configuration of metadata added to a selected frame in the first embodiment.

FIG. 6 is a flowchart of a video content playback process in the first embodiment.

FIG. 7 is a diagram showing an example of notification of haptic information.

FIG. 8 is a block diagram showing a configuration of the image processing apparatus and the like in a second embodiment.

FIG. 9 is a flowchart of a video content generation process in the second embodiment.

FIG. 10 is a diagram showing an example of three-dimensional object information.

FIG. 11 is a diagram showing a configuration of metadata added to a selected frame in the second embodiment.

FIG. 12 is a flowchart of a video content playback process in the second embodiment.

FIGS. 13A and 13B are diagrams each showing an example of generation of an output image.

FIG. 14 is a diagram showing an example of notification of haptic information.

FIG. 15 is a block diagram showing a configuration of a distribution system in a third embodiment.

FIG. 16 is a flowchart showing the operation of a distribution server.

### DESCRIPTION OF THE EMBODIMENTS

The present disclosure will now be described in detail below with reference to the accompanying drawings showing embodiments thereof. Configurations described in the following embodiments are given only by way of example, and are by no means intended to limit the scope of the present disclosure. For example, components of the configurations of the present disclosure can be replaced with desired components which can exhibit the same functions. Further, desired components can be added. Further, two or more desired components (features) of the embodiments can be combined.

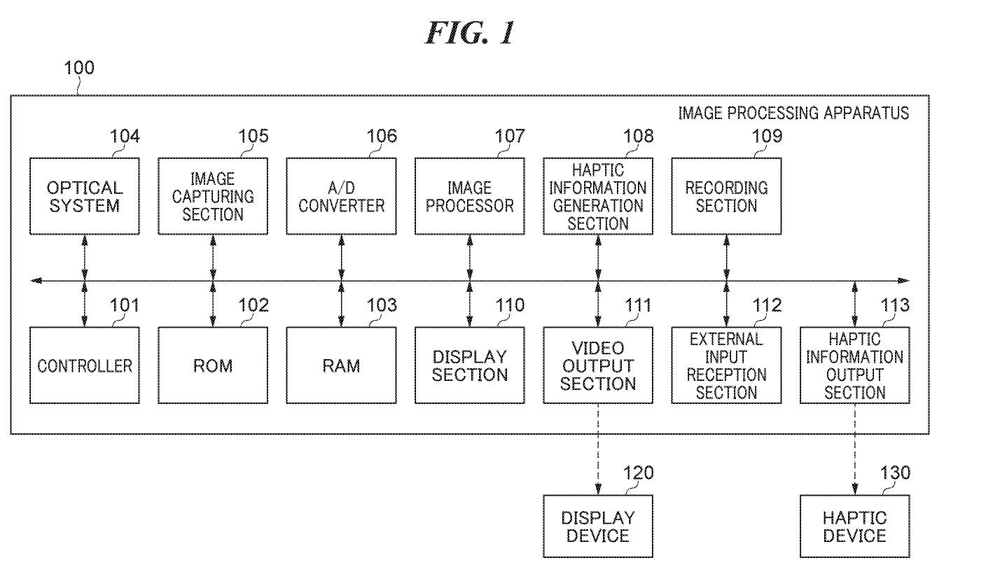

A first embodiment will be described below with reference to FIGS. 1 to 7. In the first embodiment, when video content is generated and recorded, haptic information and shielding information indicating whether or not an object for which the haptic information has been generated exists in an occlusion area are recorded in addition to the video content. Further, while a viewer is viewing the video content, existence of the haptic information of the object existing in the occlusion area is notified to the viewer according to the shielding information, and the haptic information is output in response to a request from the viewer. Note that in the first embodiment, as an example of application of the present disclosure, a description will be given of a case where haptic information of the front side of an object existing in an occlusion area is generated, but an example of application of the present disclosure is not limited to this. For example, as an example of application of the present disclosure, not only the haptic information of the front side of an object, but also haptic information of the rear side of the object can be generated regardless of whether or not the object exists in the occlusion area.

FIG. 1 is a block diagram showing a configuration of an image processing apparatus 100 and so forth. Note that the image processing apparatus 100 is a digital camera but can be a laptop-type personal computer (PC) or a mobile terminal with a camera, such as a smartphone or a tablet.

In the image processing apparatus 100, a controller 101 is e.g. a central processing unit (CPU). The controller 101 reads out operation programs for blocks included in the image processing apparatus 100 from a read only memory (ROM) 102, loads the operation programs into a random access memory (RAM) 103, and executes the loaded programs. With this, the controller 101 controls operations of the blocks included in the image processing apparatus 100. The ROM 102 is an electrically erasable/recordable nonvolatile memory. In the ROM 102, there are stored not only the operation programs for the blocks included in the image processing apparatus 100, but also parameters and the like necessary for the operations of the blocks. The RAM 103 is a rewritable volatile memory. The RAM 103 is used for loading a program executed e.g. by the controller 101 and temporarily storing data generated by the operations of the blocks included in the image processing apparatus 100.

An optical system 104 is formed by a lens group including a zoom lens and a focus lens, and a diaphragm mechanism, and causes an object image to be formed on an imaging surface of an image capturing section 105. The image capturing section 105 is an image sensor, such as a charge coupled device (CCD) or a complementary metal-oxide-semiconductor (CMOS) sensor. The image capturing section 105 photoelectrically converts an optical image formed on its imaging surface by the optical system 104 and outputs analog image data obtained by photoelectric conversion to an analog-to-digital (A/D) converter 106. The A/D converter 106 converts the analog image data input thereto to digital image data and outputs the digital image data. The digital image data output from the A/D converter 106 is temporarily stored in the RAM 103.

An image processor 107 performs a variety of image processing operations on the digital image data temporarily stored in the RAM 103. Specifically, the image processor 107 performs the variety of image processing operations (such as demosaicing processing, noise reduction processing, white balance correction processing, and gamma processing) for developing, displaying, and recording the digital image data. Further, the image processor 107 performs edit processing on a moving image when processing for generating video content is performed. Further, the image processor 107 performs processing for superimposing a symbol indicating existence of haptic information on a digital image after the digital image is recorded in a recording medium of a recording section 109, described hereinafter. Details of this processing will be described hereinafter. A haptic information generation section 108 generates, when video content is generated, haptic information according to the generated content. Details of this processing will also be described hereinafter. The recording section 109 records a variety of data including the digital image data and the haptic information in a recording medium incorporated therein.

A display section 110 includes a display device, such as a liquid crystal display (LCD), and displays the digital image data temporarily stored in the RAM 103 and the digital image data recorded in the recording section 109 on this display device. The display section 110 is used when a moving image is edited and when metadata including haptic information is added in the processing for generating video content. Further, the display section 110 includes an input device, such as a touch panel, and can receive an instruction provided e.g. by a touch operation from a user via the input device. A video output section 111 outputs digital image data on which image processing has been performed by the image processor 107 and digital image data recorded in the recording section 109 e.g. to an external monitor and a video distribution application.

An external input reception section 112 receives an external input from a viewer. Specifically, the external input reception section 112 receives a request for outputting haptic information of a desired object e.g. from a viewer viewing video content. A haptic information output section 113 outputs haptic information recorded in the recording section 109 according to an external input from a viewer. In the first embodiment, the output destination of the video output section 111 is set to a display device 120. Further, the output destination of the haptic information output section 130 is set to a haptic device 130. Note that the output destination of the video output section 111 can be e.g. a head mount display.

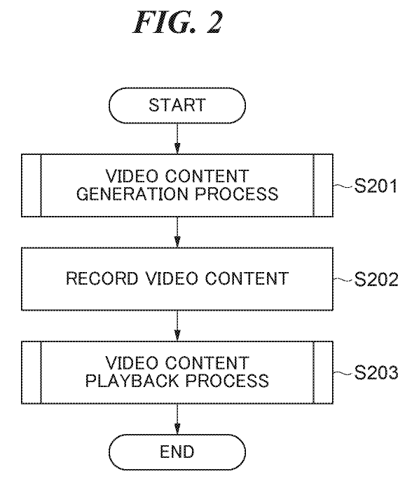

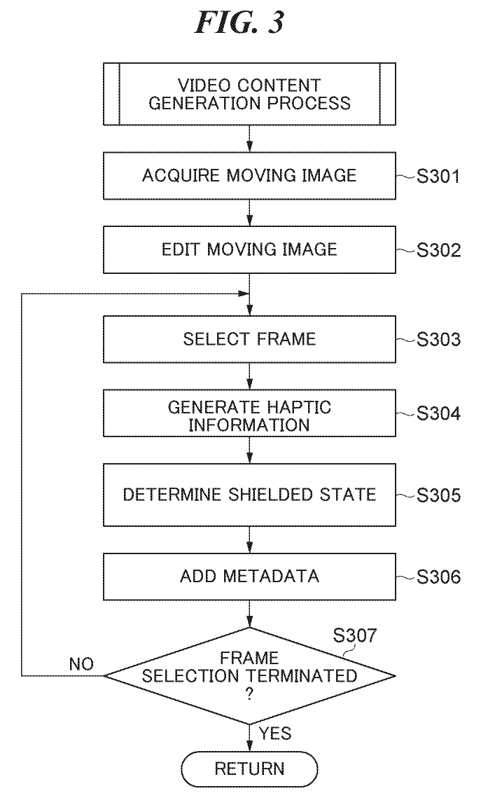

Next, the operation of the image processing apparatus 100 will be described with reference to FIG. 2. FIG. 2 is a flowchart of a process for controlling the operation of the image processing apparatus 100. The control process in FIG. 2 (the method of controlling image processing) is realized by the controller 101 (computer) that loads a program stored in the ROM 102 into the RAM 103 and executes the loaded program. When the control process in FIG. 2 is started, in a step S201, the controller 101 performs a video content generation process. The video content generation process will be described below with reference to FIG. 3.

FIG. 3 is a flowchart of the video content generation process. When the video content generation process in FIG. 3 is started, in a step S301, the controller 101 acquires a moving image. Specifically, the controller 101 controls the optical system 104 and the image capturing section 105 to acquire a desired moving image according to a scenario set in advance. Further, the controller 101 controls the A/D converter 106 and the image processor 107 to perform predetermined processing on the acquired moving image. Then, the controller 101 controls the recording section 109 to temporarily record the moving image on which the predetermined processing has been performed in its recording medium.

In a step S302, the controller 101 edits the moving image. In doing this, the controller 101 controls the image processor 107 to perform predetermined edit processing, such as exposure adjustment, color collection processing, and color grading processing, on the moving image stored in the recording section 109 according to an instruction provided from an editor via the display section 110. Then, the controller 101 controls the recording section 109 to temporarily record the moving image on which the edit processing has been performed in its recording medium.

In a step S303, the controller 101 sequentially selects frames to which haptic information is to be added. The frame to be selected is a desired frame in the moving image which has been edited and temporarily stored in the recording medium as described above. Examples of the method of selecting a frame include a method of selecting frames sequentially from the top, and a method of selecting a frame at a predetermined interval. Note that the frame selected in the step S303 is hereinafter referred to as the target frame.

In a step S304, the controller 101 (generation unit) controls the haptic information generation section 108 to generate haptic information (generation). The haptic information refers to information indicating haptic feel, such as hardness and unevenness of an object, vibration of the object, or a temperature of the object, which is measured by a predetermined sensor included in the haptic information generation section 108 in advance, and stored e.g. in the ROM 102. Further, in a case where an object is created by computer graphics, the haptic information of this object is created by a computer in advance and stored e.g. in the ROM 102. This is also the case where video content of virtual reality (VR) is generated.

The object with which the haptic information is generated in the step S304 is an object existing in the target frame and at the same time is of a type designated e.g. by an editor via the display section 110 in advance. Therefore, the haptic information generation section 108 generates haptic information by reading out haptic information of an object of the type designated e.g. by the editor in advance, out of objects existing in the target frame, e.g. from the ROM 102. Then, the controller 101 controls the recording section 109 to temporarily store the generated haptic information in its recording medium.

In a step S305, the controller 101 (determination unit) performs determination of the shielded state (determination). In doing this, the controller 101 determines whether or not the object for which the haptic information has been generated is shielded by another object in the target frame. Then, the controller 101 controls the recording section 109 to temporarily store a result of the determination in its recording medium.

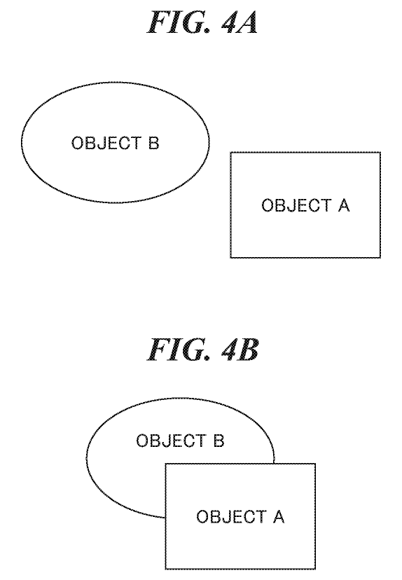

The determination of the shielded state, performed in the step S305, will be described below with reference to FIGS. 4 A and 4B. FIGS. 4A and 4B are diagrams showing an unshielded state and a shielded state of an object, respectively. Note that both of an object A and an object B, appearing in FIGS. 4A and 4B, are objects for which the haptic information has been generated. FIGS. 4A and 4B each show a case where the object A exists on the nearer side than the object B. In the case shown in FIG. 4A, the object A and the object B do not overlap, and hence the objects are in the unshielded state. On the other hand, in the case shown in FIG. 4B, part of the object B overlaps the object A and is hidden by the object A, and hence the part of the object B is not visible. Therefore, the object B is in the shielded state.

Examples of the method of determining the shielded state include a method of detecting positions and sizes of objects existing in a target frame by object detection or tracking processing, and determining the shielded state based on a degree of overlap of the objects, acquired by using the detected positions and sizes. For example, in a case where the object A and the object B, appearing in FIG. 4B, are included in the target frame, if a ratio equal to or larger than a predetermined ratio of an area of the object B overlaps the object A, the controller 101 determines that the object B is in the shielded state. Note that the method of determining the shielded state is not limited to the above-described method, and, for example, the determination of the shielded state can be performed based on the editor’s judgement.

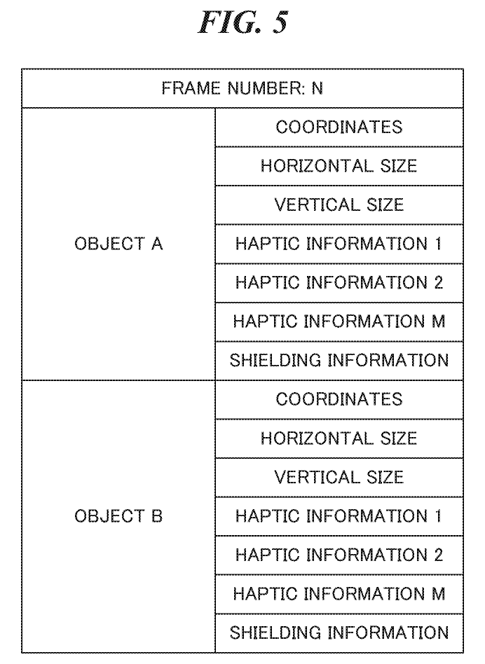

The description refers again to FIG. 3. In a step S306, the controller 101 (addition unit) adds metadata to the target frame (addition). FIG. 5 is a diagram showing a configuration of the metadata added to the target frame. As shown in FIG. 5, the metadata is formed by a frame number of the target frame, and coordinates (i.e., positional information), a horizontal size, a vertical size, haptic information items, and the shielding information of each object for which the haptic information has been generated. Note that in FIG. 5, the coordinates, the horizontal size, and the vertical size correspond to two-dimensional object information. Further, out of the haptic information items, the haptic information 3 to the haptic information M-1 are omitted. However, the haptic information is only required to include one or more haptic information items Further, the shielding information is a flag indicating a result of the above-described determination. In the first embodiment, the shielding information is a binary flag of “0” or “1” indicating whether or not an object is in the shielded state, but is not limited to this, and can be a multi-value indicating a degree of overlap.

The description refers again to FIG. 3. In a step S307, the controller 101 determines whether or not selection of the frame has been terminated. If it is determined by the controller 101 that selection of the frame has not been terminated, the process returns to the step S303. On the other hand, if it is determined by the controller 101 that selection of the frame has been terminated, the video content generation process is terminated. With this, the video content formed by the moving image having the metadata added to each of the plurality of frames thereof is generated. After that, the process returns to the control process in FIG. 2 and proceeds to a step S202.

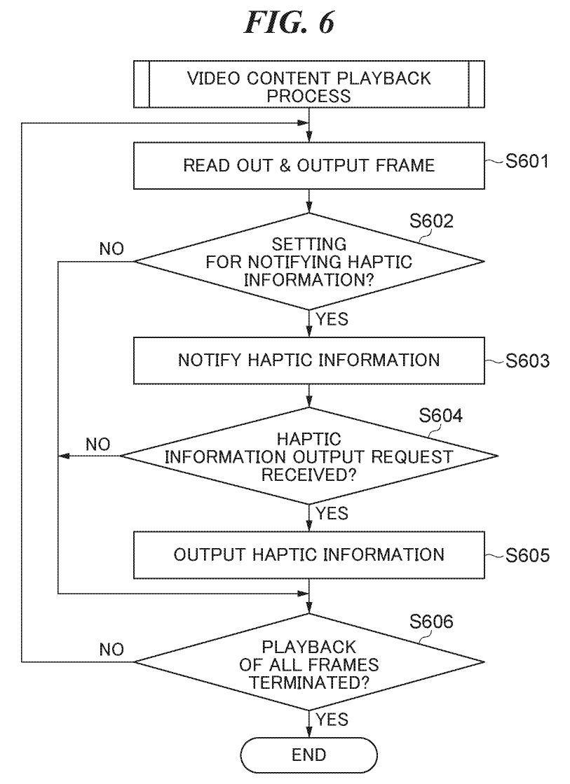

In the step S202, the controller 101 controls the recording section 109 to record the generated video content in its recording medium. In a step S203, the controller 101 performs a video content playback process. Note that in the first embodiment, the video content is assumed to be output from the video output section 111 and reproduced by the display device 120. The video content playback process will be described below with reference to FIG. 6.

FIG. 6 is a flowchart of the video content playback process. When the video content playback process in FIG. 6 is started, in a step S601, the controller 101 controls the recording section 109 to read out a frame of the moving image from its recording medium. Further, the controller 101 outputs the read frame of the moving image to the display device 120 via the video output section 111. With this, in the display device 120, the read frame of the moving image, i.e. the video content is reproduced. Note that readout of the frames of the moving image is sequentially performed in a range designated by the viewer (i.e., from a desired playback position to a termination position) via the display section 110.

In a step S602, the controller 101 determines whether or not a setting for notifying haptic information has been made. Note that the setting for notifying haptic information can be set, e.g. by the viewer via the display section 110 in advance. If it is determined by the controller 101 that the setting for notifying haptic information has not been set, the process proceeds to a step S606, described hereinafter. On the other hand, if it is determined by the controller 101 that the setting for notifying haptic information has been made, the process proceeds a step S603.

In the step S603, the controller 101 (notification unit) controls the image processor 107 to notify the haptic information. In doing this, the image processor 107 highlights the read frame of the moving image to notify existence of the haptic information. To do this, the image processor 107 superimposes a symbol indicating existence of the haptic information on the read frame of the moving image and outputs the frame of the moving image, on which the symbol has been superimposed, to the display device 120 via the video output section 111.

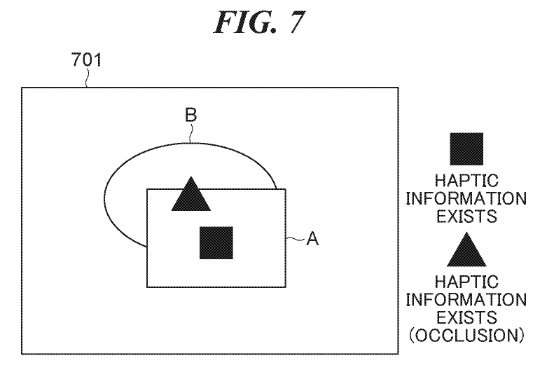

The notification of the haptic information, performed in the step S603, will be described below with reference to FIG. 7. FIG. 7 is a diagram showing an example of notification of haptic information. Reference numeral 701 denotes the frame of the moving image, which has been read out and displayed on the display device 120. In the frame 701, an object A exists on the near side of an object B and is in the unshielded state. On the other hand, the object B has part thereof shielded by the object A and is in the occlusion area, and hence in the shielded state. A black square symbol indicates that the haptic information of the object A in the unshielded state exists. A black triangular symbol indicates that the haptic information of the object B in the shielded state exists. That is, existence of the haptic information of the object B determined to be in the shielded state is notified in a different form from the notification of existence of the haptic information of the object A determined not to be in the shielded state. Note that whether or not an object is in the shielded state (or unshielded state) and the position of display of the symbol are determined according to the metadata added to the frame 701. Further, a message indicating meaning of each symbol can be superimposed on the frame 701.

Thus, since existence of the haptic information is indicated by either of the symbols which are different depending on whether or not an object is in the shielded state, existence of the haptic information of an object in the occlusion area is notified to the viewer in the intuitive form. Note that, for example, there is a case where the occlusion area exists on a far side, such as a case where another object (second object is hidden behind the object B (first object). In this case, existence of the haptic information of the object in the occlusion area, existing on the far side, is notified to the viewer by using another different symbol in the intuitive form. Note that although in the example of the haptic information, shown in FIG. 7, existence of the haptic information of the object in the occlusion area is notified by changing the shape of the symbol, this is not limitative, but, for example, existence of the haptic information can be notified by changing the color of the symbol.

The description refers again to FIG. 6. In a step S604, the controller 101 determines whether or not a request for outputting the haptic information has been received. The haptic information output request is provided by the viewer referring to the notification indicated by the symbols shown in FIG. 7 and is received via the external input reception section 112. Further, the haptic information output request is provided, for example, when the viewer selects a desired object by using a controller or selects a desired object by using a touch panel. If it is determined by the controller 101 that a haptic information output request has not been received, the process proceeds to the step S606, described hereinafter. On the other hand, if it is determined by the controller 101 that a haptic information output request has been received, the process proceeds to a step S605.

In the step S605, the controller 101 (output unit) controls the haptic information output section 113 to output the haptic information. The haptic information output section 113 acquires the haptic information of an object selected by the haptic information output request from the metadata added to the read frame of the moving image and outputs the acquired haptic information to the haptic device 130. In doing this, out of all haptic information items included in the metadata, the haptic information output section 113 selects and outputs the haptic information adapted to the haptic device 130. However, the haptic information output section 113 can output all of the haptic information items included in the metadata to the haptic device 130. In this case, out of all of the haptic information items received from the haptic information output section 113, the haptic device 130 selects the haptic information adapted to itself. Note that the haptic device 130 is a device having a desired shape, such as a glove, a ball, and a suit, and is held or worn by a viewer to thereby output the haptic information to this viewer.

In the step S606, the controller 101 determines whether or not playback of all frames of the range designated by the viewer has been terminated. If it is determined by the controller 101 that playback of all frames of the range designated by the viewer has not been terminated, the process returns to the step S601. On the other hand, if it is determined by the controller 101 that playback of all frames of the range designated by the viewer has been terminated, the video content playback process is terminated, and the control process in FIG. 2 is also terminated.

From the above, the image processing apparatus 100 can intuitively notify the viewer of existence of the haptic information of an object existing in the occlusion area. This enables the image processing apparatus 100 to indicate the object existing in the occlusion area by hepatic sensation without hindering viewing of the video content. Thus, the image processing apparatus 100 can enhance the realism of the video content.

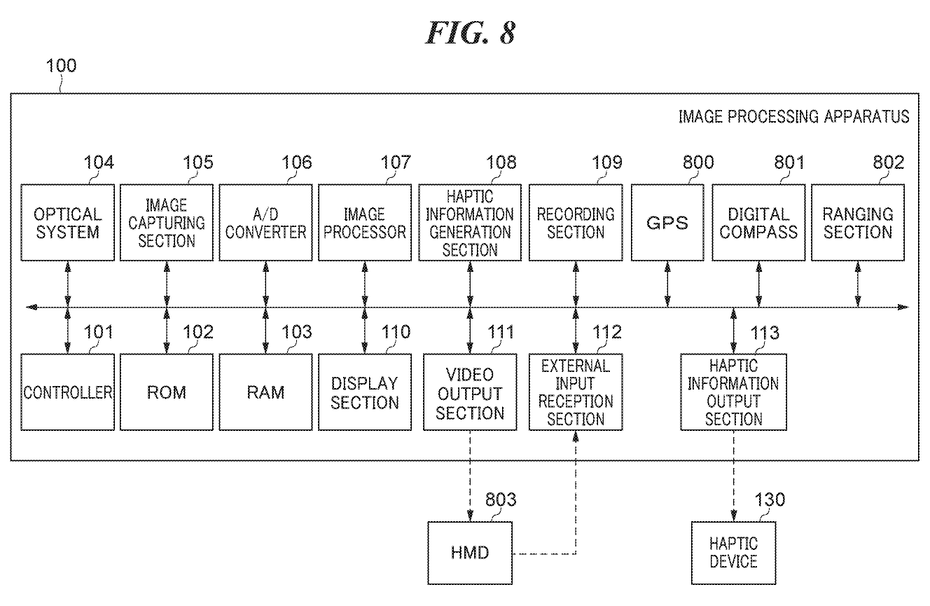

A second embodiment will be described below with reference to FIGS. 8 to 14. In the first embodiment, the description has been given of the method of enhancing the realism of the video content by including the haptic information and the shielding information in the metadata added to each frame of the video content. In the second embodiment, a description will be given of a method of enhancing the realism of the video content by notifying a viewer of existence of haptic information of an object in the shielded state when the video content is reproduced from a desired point of view. Note that in the second embodiment, different points from the first embodiment will be described. Further, the same components and processing as those of the first embodiment are denoted by the same reference numerals, and description thereof is omitted.

FIG. 8 is a block diagram showing a configuration of the image processing apparatus 100 and so forth. The image processing apparatus 100 includes a global positioning system (GPS) 800, a digital compass 801, and a ranging section 802. The GPS 800 is a GPS sensor for receiving a GPS signal from a GPS satellite and acquires positional information of the image processing apparatus 100. The digital compass 801 is a magnetic sensor for detecting terrestrial magnetism and acquires information of an image capturing direction of the image processing apparatus 100. The ranging section 802 measures a distance from the image processing apparatus 100 to each object area as a ranging target. The ranging section 802 measures the distance from the image processing apparatus 100 to the object area based on e.g. a phase difference detected by focus detecting means using the phase difference detection method and the positional information of the lens of the optical system 104. Reference numeral 803 denotes a head mount display (hereinafter referred to as the “HMD”). In the second embodiment, the output destination of the video output section 111 is the HMD 803. Further, information from the HMD 803 is input to the external input reception section 112.

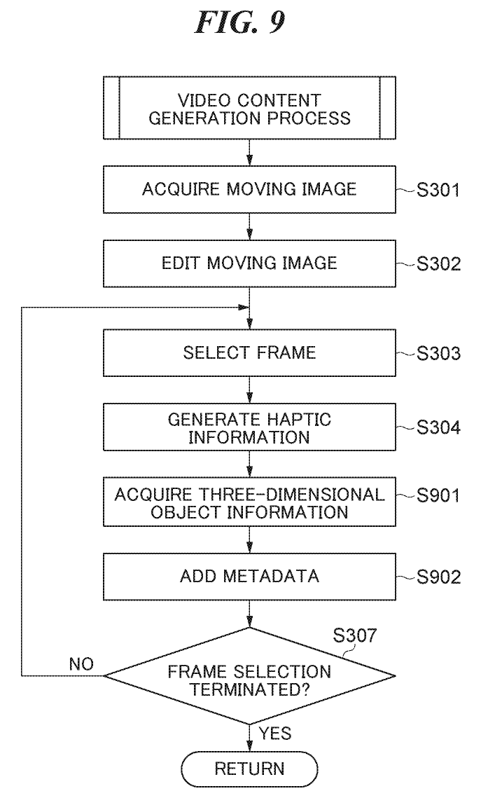

FIG. 9 is a flowchart of the video content generation process in the step S201 of the control process in FIG. 2, which is executed in the second embodiment. Note that in the second embodiment, the position and shape of an object are three-dimensionally acquired so as to make it possible to reproduce the video content from a desired point of view. Then, in a step S901, the controller 101 (first acquisition unit) acquires the three-dimensional object information of an object included in the target frame by using the GPS 800, the digital compass 801, the ranging section 802, and so forth (first acquisition).

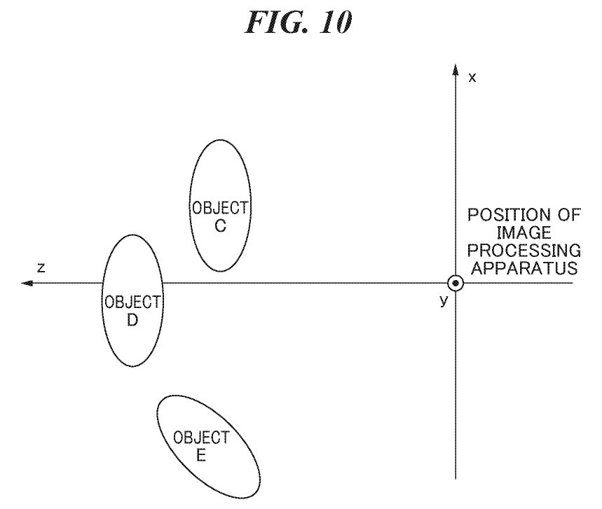

FIG. 10 is a diagram showing an example of the three-dimensional object information. As shown in FIG. 10, the three-dimensional object information is formed by respective positions and sizes in an x direction, a y direction, and a z direction, of an object having the position of the image processing apparatus 100 as an origin. In the illustrated example in FIG. 10, three objects C to E are included in the target frame, and hence the respective three-dimensional object information items of the three objects C to E are acquired. Acquisition of the three-dimensional object information is performed with respect to a main object included in the target frame regardless of whether or not the haptic information has been acquired. Examples of the method of acquiring the three-dimensional object information include a method of acquiring the three-dimensional object information based on the absolute position and size of an object, which are stored when a moving image has been acquired, and the absolute position of the image processing apparatus 100 at a time when the target frame has been acquired. Further, in a case where an object is created by computer graphics, it is possible to use a method of acquiring the three-dimensional object information based on the absolute position and size of the object arranged by the computer, and the absolute position of the image processing apparatus 100 at a time when the target frame has been acquired. Note that the position of the origin is not limited to the position of the image processing apparatus 100, but, for example, it can be a position of a desired point in a space coordinate system.

The description refers again to FIG. 9. In a step S902, the controller 101 (addition unit) adds metadata to the target frame (addition). Then, the process proceeds to the step S307. Note that in the second embodiment, differently from the first embodiment, the shielding information is not included in the metadata, and the determination of the shielded state is performed in the video content playback process, described hereinafter.

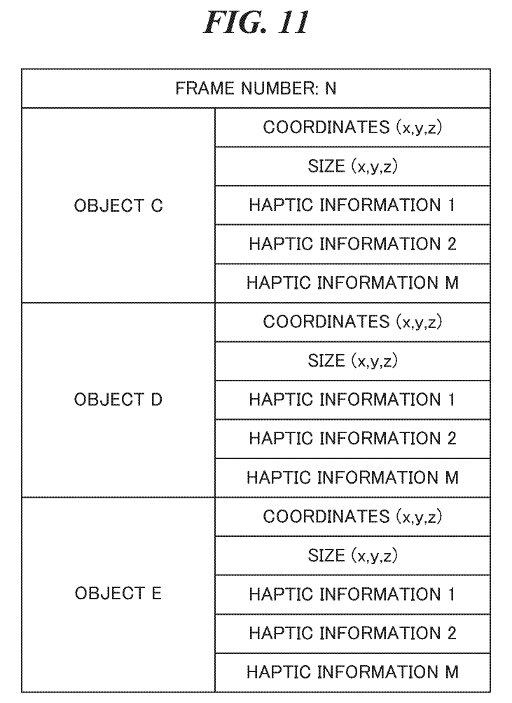

FIG. 11 is a diagram showing a configuration of metadata added to a target frame in the second embodiment. The metadata shown in FIG. 11 is formed by a frame number of the target frame, and coordinates (i.e., positional information), a size, and haptic information items of each object for which the haptic information has been generated. Note that as described above, the determination of the shielded state is performed in the video content playback process, described hereinafter, and hence the coordinates (i.e., positional information) and the size of an object for which the haptic information has not been generated are also included in the metadata. However, to simplify the processing, with respect to an object for which the haptic information has not been generated, coordinates (i.e., positional information) and a size of only an object having a size equal to larger than a predetermined size and existing within a predetermined distance from the image processing apparatus 100 can be included in the metadata.

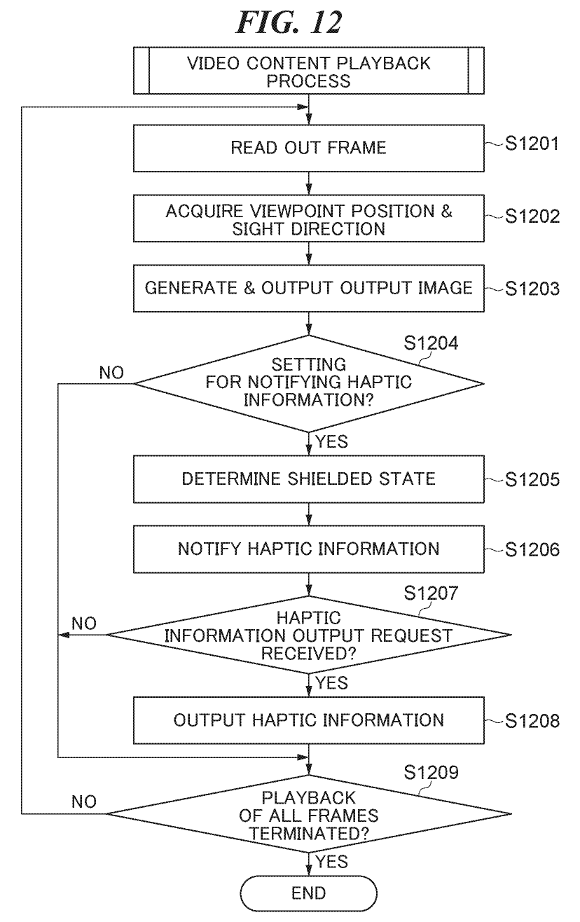

FIG. 12 is a flowchart of the video content playback process in the step S203 of the control process in FIG. 2, which is executed in the second embodiment. Note that in the second embodiment, it is assumed that the video content is output from the video output section 111 and is reproduced by the HMD 803 worn by the viewer. When the video content playback process in FIG. 12 is started, in a step S1201, the controller 101 controls the recording section 109 to read out a frame of the moving image from its recording medium. Note that readout of the frames of the moving image is sequentially performed in a range designated by the viewer (i.e., from a desired playback position to a termination position) via the display section 110.

In a step S1202, the controller 101 (second acquisition unit) acquires a viewpoint position and a sight direction via the external input reception section 112 (second acquisition). The viewpoint position and the sight direction are the position and the direction of the HMD 803 in the three-dimensional space being viewed by the viewer wearing the HMD 803. Note that in a case where the viewpoint is not moved (such as a case where the output destination of the video output section 111 is the display device 120), the position and the image capturing direction of the image processing apparatus 100 can be acquired as the viewpoint position and the sight direction.

In a step S1203, the controller 101 controls the image processor 107 to generate an output image. The output image is generated by projection-converting the read frame of the moving image from the three-dimensional coordinate system at a time when the read frame of the moving image has been acquired to the two-dimensional screen coordinate system according to the viewpoint position and the sight direction. Thus, the output image is reconstructed based on the viewpoint position of the viewer, and then output to the HMD 803 worn by the viewer via the video output section 111. With this, on the HMD 803, the read frame of the moving image, i.e., the video content is reproduced.

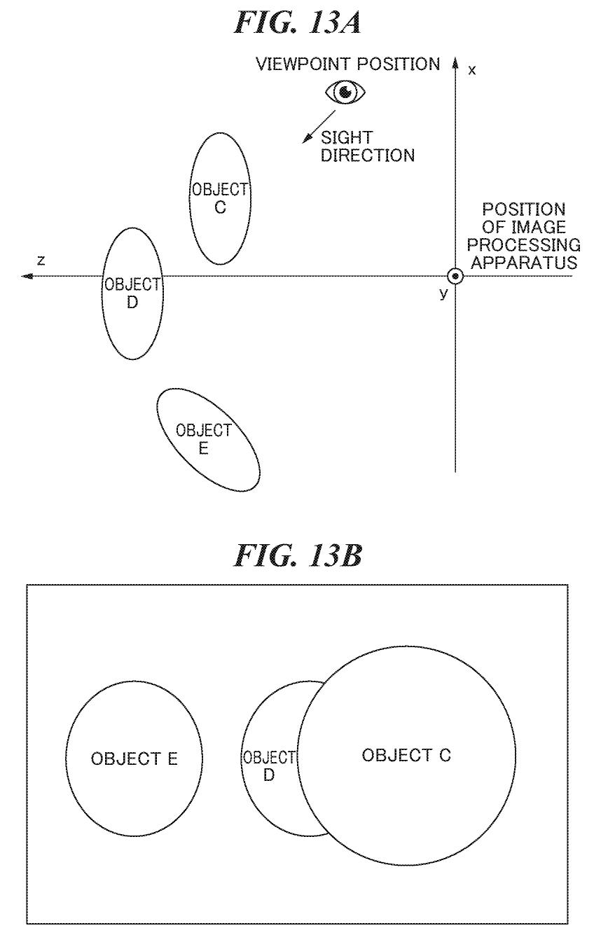

FIGS. 13A and 13B are diagrams each showing an example of generation of an output image. FIG. 13A is a diagram showing an example of the viewpoint position and the sight direction. FIG. 13B is a diagram showing an example of an output image generated by projection-converting the read frame of the moving image from the three-dimensional coordinate system to the two-dimensional screen coordinate system according to the viewpoint position and the sight direction shown in FIG. 13A. Note that in the projection conversion, a known method of converting an image from the world coordinate system to the screen coordinate system of the sight direction is used.

The description refers again to FIG. 12. In a step S1204, the controller 101 determines whether or not a setting for notifying the haptic information has been made. If it is determined by the controller 101 that the setting for notifying the haptic information has not been made, the process proceeds to a step S1209, described hereinafter. On the other hand, if it is determined by the controller 101 that the setting for notifying the haptic information has been made, the process proceeds to a step S1205.

In the step S1205, the controller 101 (determination unit) performs the determination of the shielding state (determination). In doing this, the controller 101 determines whether or not an object for which the haptic information has been generated is shielded by another object in the output image on which the projection conversion has been performed. Then, the controller 101 controls the recording section 109 to temporarily record information indicating a result of the determination in its recording medium. Note that in the illustrated example in FIG. 13B, it is determined that an object C and an object E are in the unshielded state, and an object D is in the shielded state. Note that the determination of the shielded state, which is performed in the step S1205, uses the same method as that of the determination of the shielded state, which is performed in the step S305.

The description refers again to FIG. 12. In a step S1206, the controller 101 (notification unit) controls the image processor 107 to notify the haptic information. In doing this, the image processor 107 highlights the output image after being subjected to the projection conversion so as to notify existence of the haptic information according to a result of the above-described determination and the haptic information included in the metadata added to the read frame of the moving image. To do this, the image processor 107 superimposes a symbol indicating existence of the haptic information on the output image after being subjected to the projection conversion and outputs the output moving image with the superimposed symbol to the HMD 803 via the video output section 111.

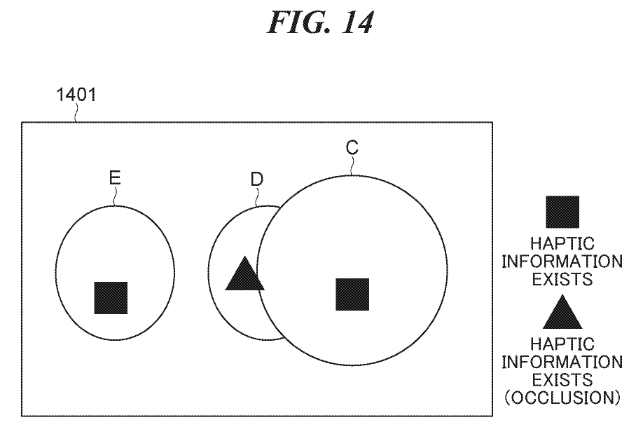

FIG. 14 is a diagram showing an example of notification of the haptic information. Reference numeral 1401 denotes the output moving image displayed on the HMD 803, after being subjected to the projection conversion. Similar to the first embodiment, in the illustrated example in FIG. 14, existence of the haptic information of the object D, determined to be in the shielded state, is notified in a form different from the notification of existence of the respective haptic information items of the object C and the object E, which are determined not to be in the shielded state. With this, existence of the haptic information of the object D, which is determined to be in the shielded state, and existence of the respective haptic information items of the object C and the object E, determined not to be in the shielded state, are intuitively notified to the viewer.

The description refers again to FIG. 12. In a step S1207, the controller 101 determines whether or not a request for outputting the haptic information has been made. The haptic information output request is made by the viewer referring to the notification indicated by the symbols shown in FIG. 14 and is received by the external input reception section 112. Further, similar to the step S604, the haptic information output request is made by the viewer selecting a desired object by using a controller, or selecting a desired object by using a touch panel, or the like. If it is determined by the controller 101 that a haptic information output request has not been received, the process proceeds to the step S1209, described hereinafter. On the other hand, if it is determined by the controller 101 that a haptic information output request has been received, the process proceeds to a step S1208.

In the step S1208, the controller 101 (output unit) controls the haptic information output section 113 to output the haptic information. Similar to the step S605, the haptic information output section 113 acquires the haptic information of the object selected by the haptic information output request from the metadata added to the read frame of the moving image and outputs the acquired haptic information to the haptic device 130.

In the step S1209, the controller 101 determines whether or not playback of all frames of the range designated by the viewer has been terminated. If it is determined by the controller 101 that playback of all frames of the range designated by the viewer has not been terminated, the process returns to the step S1201. On the other hand, if it is determined by the controller 101 that playback of all frames of the range designated by the viewer has been terminated, the video content playback process is terminated, and the control process in FIG. 2 is also terminated.

From the above, even in a case where an output image is generated to reproduce the video content from a desired viewpoint on the HMD 803, the image processing apparatus 100 can also intuitively notify the viewer of existence of the haptic information of an object existing in the occlusion area. This enables the image processing apparatus 100 to tactually indicate the object existing in the occlusion area without hindering viewing of the video content. Thus, the image processing apparatus 100 can enhance the realism of the video content.

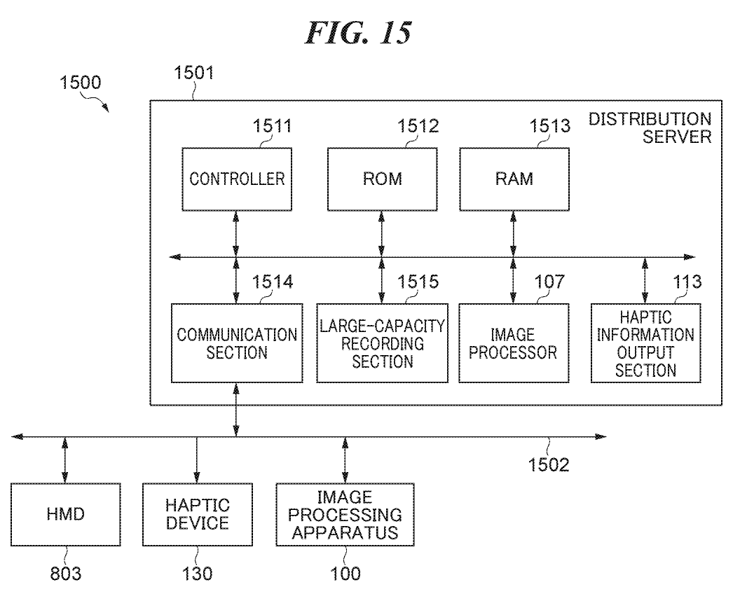

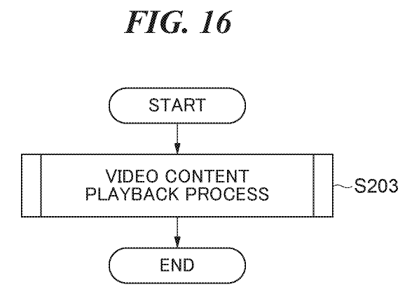

A third embodiment will be described below with reference to FIGS. 15 and 16, and the like. In the third embodiment, a description will be given of a method of enhancing the realism of video content by notifying existence of haptic information of an object in the shielded state when the video content distributed by a distribution server is reproduced by the HMD. Note that in the third embodiment, different points from the first and second embodiments will be described. Further, the same components and processing as those of the first and second embodiments are denoted by the same reference numerals, and description thereof is omitted.

FIG. 15 is a block diagram showing a configuration of a distribution system 1500. In the distribution system 1500, not only the image processing apparatus 100, the haptic device 130, and the HMD 803, described above, but also a distribution server 1501 is connected to a communication network 1502. Note that in place of the HMD 803, the display device 120 can be connected to the communication network 1502. The distribution server 1501 includes a controller 1511, a ROM 1512, a RAM 1513, a communication section 1514, a large-capacity recording section 1515, the image processor 107, and the haptic information output section 113. The controller 1511, the ROM 1512, and the RAM 1513 are the same as the controller 101, the ROM 102, and the RAM 103, and hence detailed description of these is omitted.

The communication section 1514 is a communication unit for realizing wired communication (such as the Internet communication) via the communication network 1502. The large-capacity recording section 1515 records video content and the like in a recording medium incorporated therein. As the recording medium, a hard disk drive (HDD) fixedly disposed in the distribution server 1501 is used. Note that as the recording medium, a solid state drive (SSD) formed by a flash memory, a hybrid drive using both of a hard disk and a flash memory, a memory card, or the like can be used. In the large-capacity recording section 1515, for example, video content supplied from the image processing apparatus 100 e.g. via the communication section 1514 and the like are recorded. Note that the video content supplied from the image processing apparatus 100 are the video content generated in the step S201.

FIG. 16 is a flowchart showing the operation of the distribution server 1501. The control process in FIG. 16 (method of reproducing an image) is realized by the controller 1511 that loads a program stored in the ROM 1512 into the RAM 1513 and executes the loaded program. When the control process in FIG. 16 is started, the video content playback process in the step S203 is executed by the controller 1511. Then, the control process in FIG. 16 is terminated. As the video content playback process in the step S203, the controller 1511 performs the video content playback process in FIG. 6 or the video content playback process in FIG. 12.

However, in a case where the video content playback process in FIG. 6 is performed, in the step S601, the controller 1511 reads out a frame of a moving image from the recording medium of the large-capacity recording section 1515, in which the video content is sored. Further, the controller 1511 outputs the read frame of the moving image to the HMD 803 worn by the viewer via the communication section 1514. With this, on the HMD 803, the read frame of the moving image, i.e., the video content is reproduced.

Further, in the step S603, the controller 1511 controls the image processor 107 to notify the haptic information (notification). In doing this, the image processor 107 superimposes a symbol indicating existence of the haptic information on the read frame of the moving image and outputs the frame of the moving image, on which the symbol has been superimposed, to the HMD 803 via the communication section 1514.

Further, in the step S605, the controller 1511 outputs the haptic information via the communication section 1514 (output). In doing this, the controller 1511 acquires the haptic information of an object selected by the haptic information output request from the metadata added to the read frame of the moving image and outputs the acquired haptic information to the haptic device 130 via the communication section 1514. Note that the haptic information can be output to the haptic device 130 via the HMD 803.

Note that in the case where the video content playback process in FIG. 6 is performed, the video content can be reproduced by the display device 120. In this case, the display device 120 in place of the HMD 803 is connected to the communication network 1502. Further, the haptic information can be output to the haptic device 130 via the display device 120.

On the other hand, in a case where the video content playback process in FIG. 12 is performed, in the step S1201, the controller 1511 reads out a frame of the moving image from the recording medium of the large-capacity recording section 1515, in which the video content is stored. Further, in the step S1202, the controller 1511 acquires a viewpoint position and a sight direction via the communication section 1514. Further, in the step S1203, the controller 1511 controls the image processor 107 to generate an output image. The generated output image is output to the HMD 803 via the communication section 1514. With this, on the HMD 803, the read frame of the moving image, i.e., the video content is reproduced.

Further, in the step S1206, the controller 1511 controls the image processor 107 to notify the haptic information (notification). In doing this, the image processor 107 superimposes a symbol indicating existence of the haptic information on the read frame of the moving image and outputs the frame of the moving image on which the symbol has been superimposed to the HMD 803 via the communication section 1514.

Further, in the step S1208, the controller 1511 outputs the haptic information via the communication section 1514 (output). In doing this, the controller 1511 acquires the haptic information of the object selected by the haptic information output request from the metadata added to the read frame of the moving image and outputs the acquired haptic information to the haptic device 130 via the communication section 1514. Note that the haptic information can be output to the haptic device 130 via the HMD 803.

From the above, in the distribution system 1500, the distribution server 1501 can intuitively notify the viewer of existence of the haptic information of an object existing in the occlusion area when the video content is distributed to the HMD 803 and reproduced thereon. Further, even in a case where an output image is generated in order to reproduce the video content from a desired viewpoint, the distribution server 1501 can also intuitively notify the viewer of existence of the haptic information of an object existing in the occlusion area. This enables the distribution server 1501 to tactually present the object existing in the occlusion area without hindering viewing of the video content. Thus, the distribution server 1501 can enhance the realism of the video content.

As described above, the preferred embodiments of the present disclosure have been described, but the present disclosure is not limited to the above-described embodiments, and can be modified and changed within the scope of the gist of the present disclosure. In this point, the controllers 101 and 1511 can control the image processor 107 to notify the haptic information by using the following method: For example, with respect to an object which is completely shielded (third object), to notify the viewer that the whole of this object exists in the occlusion area, the image processor 107 can superimpose information related to this object on an end of the screen of the display device 120 or the HMD 803. Note that the information related to this object includes, for example, an image of this object.

Further, in a case where metadata has not been added to a read frame of a moving image, the image processor 107 can perform interpolation using metadata added to frames before and after this frame in the step S603 and the step S605. Further, this interpolation can be performed by the display device 120 or the HMD 803. These points are also applied to the step S1206 and the step S1208. However, in this case, the image processor 107 need not notify the haptic information.

Further, although the control process of the image processing apparatus 100 in FIG. 2 is performed on each frame of the moving image, which is read out from the video content, this is not limitative, but, for example, the operation can be performed on only one still image. This point is also applied to the operation of the distribution server 1501 in the process in FIG. 16.

According to the present disclosure, it is possible to tactually indicate an object existing in an occlusion area without hindering viewing of an image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-068003, filed April 15, 2025, which is hereby incorporated by reference herein in its entirety.

What is claimed is:

1. An image processing apparatus including:
at least one processor; and
a memory storing instructions that, when executed by the at least one processor, causes the at least one processor to function as:
a generation unit configured to generate haptic information used when indicating an object included in an image by haptic sensation;
a determination unit configured to acquire a result of determination on whether or not an object for which the haptic information has been generated exists in an occlusion area in the image, as shielding information; and
an addition unit configured to add metadata having the haptic information and the shielding information to the image.

2. The image processing apparatus according to claim 1, wherein the determination unit performs the determination when the image is generated.

3. The image processing apparatus according to claim 1, wherein the metadata includes not only the haptic information and the shielding information, but also two-dimensional object information of the object for which the haptic information has been generated.

4. The image processing apparatus according to claim 1, further comprising a notification unit configured to notify existence of the haptic information on an object existing in an occlusion area in the image.

5. The image processing apparatus according to claim 4, wherein the notification unit performs notification indicating existence of the haptic information on an object existing in an occlusion area in the image and notification indicating existence of the haptic information on an object not existing in an occlusion area in the image, in different forms.

6. The image processing apparatus according to claim 4, wherein the notification unit performs notification indicating existence of the haptic information on a first object existing in an occlusion area in the image and notification indicating existence of the haptic information on a second object existing in an occlusion area behind the first object in the image, in different forms.

7. The image processing apparatus according to claim 4, wherein in a case where the notification unit notifies existence of the haptic information on a third object the whole of which is included in an occlusion area in the image, the notification unit superimposes information related to the third object on the image.

8. The image processing apparatus according to claim 4, wherein the notification unit does not perform the notification in a case where the metadata has not been added to the image.

9. The image processing apparatus according to claim 4, wherein in a case where the metadata has not been added to the image, the notification unit performs interpolation using the metadata items added to images preceding and following the image, respectively, out of the metadata items added in the video content having the image.

10. The image processing apparatus according to claim 1, further comprising an output unit configured to output the haptic information on an object selected by an output request from a viewer of the image to the outside.

11. The image processing apparatus according to claim 1, wherein the haptic information is information used when tactually indicating a rear side of an object included in the image.

12. An image processing apparatus including:
at least one processor; and
a memory storing instructions that, when executed by the at least one processor, causes the at least one processor to function as:
a generation unit configured to generate haptic information used when indicating an object included in an image by haptic sensation;
a first acquisition unit configured to acquire three-dimensional object information of an object included in the image;
an addition unit configured to add metadata having the haptic information and the three-dimensional object information to the image;
a second acquisition unit configured to acquire a viewpoint position and a sight direction of a viewer of the image; and
a determination unit configured to determine whether or not an object exists in an occlusion area in the image, by using the three-dimensional object information, the viewpoint position, and the sight direction.

13. The image processing apparatus according to claim 12, wherein the determination unit performs the determination when the image is reproduced.

14. The image processing apparatus according to claim 12, further comprising a notification unit configured to notify existence of the haptic information on an object existing in an occlusion area in the image.

15. The image processing apparatus according to claim 14, wherein the notification unit performs notification indicating existence of the haptic information on an object existing in an occlusion area in the image and notification indicating existence of the haptic information on an object not existing in an occlusion area in the image, in different forms.

16. The image processing apparatus according to claim 14, wherein the notification unit performs notification indicating existence of the haptic information on a first object existing in an occlusion area in the image and notification indicating existence of the haptic information on a second object existing in an occlusion area behind the first object in the image, in different forms.

17. The image processing apparatus according to claim 14, wherein in a case where the notification unit notifies existence of the haptic information on a third object the whole of which is included in an occlusion area in the image, the notification unit superimposes information related to the third object on the image.

18. The image processing apparatus according to claim 14, wherein the notification unit does not perform the notification in a case where the metadata has not been added to the image.

19. The image processing apparatus according to claim 14, wherein in a case where the metadata has not been added to the image, the notification unit performs interpolation using the metadata items added to images preceding and following the image, respectively, out of the metadata items added in the video content having the image.

20. The image processing apparatus according to claim 12, further comprising an output unit configured to output the haptic information on an object selected by an output request from a viewer of the image to the outside.

21. The image processing apparatus according to claim 12, wherein the haptic information is information used when tactually indicating a rear side of an object included in the image.

22. A method of controlling an image processing apparatus, comprising:
generating haptic information used when indicating an object included in an image by haptic sensation;
acquiring a result of determination on whether or not an object for which the haptic information has been generated exists in an occlusion area in the image as shielding information; and
adding metadata having the haptic information and the shielding information to the image.

23. A method of controlling an image processing apparatus, comprising:
generating haptic information used when indicating an object included in an image by haptic sensation;
acquiring three-dimensional object information of an object included in the image;
adding metadata having the haptic information and the three-dimensional object information to the image;
acquiring a viewpoint position and a sight direction of a viewer of the image; and
determining whether or not an object exists in an occlusion area in the image, by using the three-dimensional object information, the viewpoint position, and the sight direction.

24. A method of reproducing an image, comprising:
notifying, when an image is reproduced, existence of haptic information used when indicating an object existing in an occlusion area in the image by haptic sensation; and
at the same time, outputting the haptic information on an object selected by an output request from a viewer of the image to the outside.

25. A non-transitory computer-readable storage medium storing a program for causing a computer to execute a method of controlling an image processing apparatus,
wherein the control method comprises:
generating haptic information used when indicating an object included in an image by haptic sensation;
acquiring a result of determination on whether or not an object for which the haptic information has been generated exists in an occlusion area in the image as shielding information; and
adding metadata having the haptic information and the shielding information to the image.

26. A non-transitory computer-readable storage medium storing a program for causing a computer to execute a method of controlling an image processing apparatus,
wherein the control method comprises:
generating haptic information used when indicating an object included in an image by haptic sensation;
acquiring three-dimensional object information of an object included in the image;
adding metadata having the haptic information and the three-dimensional object information to the image;
acquiring a viewpoint position and a sight direction of a viewer of the image; and
determining whether or not an object exists in an occlusion area in the image, by using the three-dimensional object information, the viewpoint position, and the sight direction.
